(19) United States
(12) Patent Application Publication
(10) Pub. No.: US 2025/0250471 A1
(43) Pub. Date: Aug. 7, 2025

(54) EPOXY RESIN COMPOSITIONS AND USES THEREOF

(71) Applicant: Westlake Epoxy Inc., Houston, TX (US)

(72) Inventor: Frieder SCHWARZ, Kernen i.R (DE)

(21) Appl. No.: 18/429,646

(22) Filed: Feb. 1, 2024

(51) Int. Cl. C09J 163/00; C08K 5/00; C08K 7/22; C08K 9/06; C08L 63/00; C09J 11/08

(52) U.S. Cl. CPC C09J 163/00; C08K 5/0025; C08K 5/0041; C08K 7/22; C08K 9/06; C08L 63/00; C09J 11/08; C08K 2201/002; C08L 2201/00; C08L 2205/02; C08L 2205/20

(57) ABSTRACT

Embodiments of the present disclosure generally relate to epoxy resin compositions and to uses thereof. In an embodiment is provided an epoxy resin composition that includes an epoxy resin; an impact modifier; a curing agent; a first filler; and a second filler, the second filler comprising a different filler than the first filler, the second filler having a different density than the first filler. In another embodiment is provided an article that includes a first component, a second component, and an epoxy resin composition described herein disposed between the first and second components.

### FIELD

Embodiments of the present disclosure generally relate to epoxy resin compositions and to uses thereof.

### BACKGROUND

Epoxy resin compositions are utilized during the manufacture of various articles such as wind turbine blades, vehicle components, and sports equipment to bond components of such articles together. For constructing these and other articles, manufacturers desire using lightweight composite materials, such as glass fiber-reinforced plastic and carbon-fiber reinforced plastic, as well as lightweight epoxy resin compositions to bond components and parts together. During use, wind turbine blades, vehicle components, and sports equipment, among other articles, are subjected to high mechanical stresses. Therefore, epoxy resin compositions used to bond components of such articles to one another should also have good mechanical properties such as high fracture toughness and high tensile strength, as well as high sag resistance (the ability of an epoxy resin composition to resist sagging failure which is a bending or drooping of the wet epoxy resin compositions).

However, conventional lightweight epoxy resin compositions fail to resist mechanical loads as it is challenging to balance low density with high mechanical properties. Such failures under mechanical stress result in the construction of articles that do not meet their stated objectives, driving up manufacturing and servicing costs.

Therefore, there is a need for new and improved epoxy resin compositions.

### SUMMARY

Embodiments of the present disclosure generally relate to epoxy resin compositions and to uses of epoxy resin compositions. Embodiments described herein can be utilized as an adhesive in various articles such as wind turbine blades, or as an adhesive composition utilized in a process for preparing a wind turbine blade, among other applications. Unlike conventional technologies, epoxy resin compositions described herein can be lightweight while maintaining excellent mechanical properties.

In an embodiment, an epoxy resin composition is provided. The epoxy resin composition includes: an epoxy resin; an impact modifier; a curing agent; a first filler having a density of greater than 0.2 g/cm³; and a second filler having a density of 0.2 g/cm³ or less, the second filler comprising a different filler than the first filler, the second filler comprising a thermoplastic.

In another embodiment, an epoxy resin composition is provided. The epoxy resin composition includes an epoxy resin; an impact modifier; a curing agent; a first filler having a density of greater than 0.2 g/cm³; and a second filler having a density of 0.2 g/cm³ or less, the second filler comprising a different filler than the first filler. The epoxy resin composition may have a fracture toughness (at 23° C.) that is about 1,500 J/m2 or more; a tensile strain at break (at 23° C.) of about 4% or more; a density (at 20° C.) that is about 1.10 g/cm3 or less; or combinations thereof.

In another embodiment is provided an epoxy resin composition. The epoxy resin composition is an epoxy resin composition described herein adapted to bond, join, or bond composite materials together.

In another embodiment is provided an adhesive that includes an epoxy resin composition described herein.

In another embodiment, a multi-component adhesive is provided. The multicomponent adhesive comprises a resin component and a curative component. The resin component includes an epoxy resin, a first filler, a second filler, an optional additive, or combinations thereof. The curative component includes a curing agent, a first filler, an optional additive, or combinations thereof.

In another embodiment is provided an article that includes: a first component; a second component; and an epoxy resin composition described herein disposed between the first and second components.

In another embodiment is provided a wind turbine blade that includes: two components of a wind turbine blade; and an epoxy resin composition described herein disposed between the two components of the wind turbine blade.

In another embodiment is provided a wind turbine blade. The wind turbine blade includes a component of a wind turbine blade; and an epoxy resin composition disposed over the component of the wind turbine blade, the epoxy resin composition comprising: an epoxy resin; an impact modifier; a curing agent; a first filler having a density of greater than 0.2 g/cm³; and a second filler having a density of 0.2 g/cm³ or less, the second filler comprising a different filler than the first filler.

### DETAILED DESCRIPTION

Embodiments of the present disclosure generally relate to epoxy resin compositions and to uses of epoxy resin compositions such as articles of manufacture. As described above, conventional adhesive compositions are either lightweight (low density) and have poor mechanical properties or are heavy (high density) and have good mechanical properties. In contrast to conventional adhesive compositions that add significant weight to various articles such as wind turbines and vehicles, epoxy resin compositions described herein can be less dense and lighter in weight while maintaining high mechanical properties such as high tensile strain at break, high tensile strength, and high fracture toughness. In addition, epoxy resin compositions of the present disclosure have pot life and glass transition temperatures that are well suited for bonding, have high sag resistance, and resist separation upon storage.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The use of headings is for purposes of convenience only and does not limit the scope of the present disclosure. Embodiments described herein can be combined with other embodiments.

Embodiments of the present disclosure generally relate to epoxy resin compositions. Epoxy resin compositions of the present disclosure can include an epoxy resin, a curing agent, an impact modifier, a first filler, and a second filler. The epoxy resin compositions can further include one or more additives. A total weight percent (total wt %) of the epoxy resin composition is based on the total amount of components present in the epoxy resin composition. The total wt % of the epoxy resin composition is 100 wt %. In at least one embodiment, an epoxy resin composition includes an epoxy resin; a curing agent; a first filler having a density that is greater than 0.2 g/cm³; and a second filler having a density of less than 0.2 g/cm³.

Epoxy resin compositions of the present disclosure can be curable epoxy resin compositions such that the epoxy resin composition can be cured by application of a stimulus, for example, a change in temperature, as further described below. Epoxy resin compositions described herein can include a reaction product of a mixture comprising an epoxy resin, a curing agent, an impact modifier, a first filler, a second filler, and optional additives

Epoxy resin compositions described herein include one or more epoxy resins. Epoxy resins include those which can be cured by suitable curing agents. The epoxy resin can be saturated or unsaturated, aliphatic, cycloaliphatic, aromatic or heterocyclic and may be substituted. Epoxy resins can be monomeric or polymeric. Epoxy resins include those compounds containing at least one vicinal epoxy group. The epoxy resin utilized may be, for example, an epoxy resin or a combination of epoxy resins prepared from an epihalohydrin and a phenol or a phenol type compound, prepared from an epihalohydrin and an amine, prepared from an epihalohydrin and a carboxylic acid, or prepared from the oxidation of unsaturated compounds.

Suitable epoxy resins useful for embodiments described herein can include non-aromatic epoxy resins and aromatic epoxy resins. The epoxy resins can contain more than one 1,2-epoxy groups per molecule, and in some embodiments more than about 1.5 1,2-epoxy groups per molecule, and in some embodiments two 1,2-epoxy groups per molecule. The epoxy resin may be liquid or a solid. In at least one embodiment, the epoxy resin has an epoxide equivalent weight of about 100 to about 5,000, such as from about 100 to about 2,000, such as from about 100 to 500, as determined by titration methods described in ASTM D1652.

Suitable epoxy resin(s) include resins based on a polyglycidyl ether of a polyhydric phenol. Polyglycidyl ethers of polyhydric phenols can be produced, for example, by reacting an epihalohydrin with a polyhydric phenol in the presence of an alkali. Examples of suitable polyhydric phenols include, but are not limited to: 2,2-bis(4-hydroxyphenyl) propane (bisphenol-A); 2,2-bis(4-hydroxy-3-tert-butylphenylpropane; 1,1-bis(4-hydroxyphenyl) ethane; 1,1-bis(4-hydroxyphenyl) isobutane; bis(2-hydroxy-1-naphthyl) methane; 1,5-dihydroxynaphthalene; 1,1-bis(4-hydroxy-3-alkylphenyl) ethane; combinations thereof; among others. Suitable polyhydric phenols can also be obtained from the reaction of phenol with aldehydes such as formaldehyde (bisphenol-F). Fusion products of these polyglycidyl ethers of polyhydric phenols with phenolic compounds such as bisphenol-A are also suitable as epoxy resins

The epoxy resin can be non-aromatic hydrogenated cyclohexane dimethanol and diglycidyl ethers of hydrogenated bisphenol A-type epoxy resin, such as hydrogenated bisphenol A-epichlorohydrin epoxy resin, cyclohexane dimethanol diglycidylether, and cycloaliphatic epoxy resin.

In at least one embodiment, the epoxy resin utilized include an aromatic epoxy resin such as those resins produced from an epihalohydrin and a phenol or a phenol-type compound. The phenol-type compound includes compounds having an average of more than one aromatic hydroxyl group per molecule. Examples of phenol-type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

The epoxy resin utilized can include those resins produced from an epihalohydrin and bisphenols, halogenated bisphenols, hydrogenated bisphenols, novolac resins, and polyalkylene glycols, or combinations thereof.

The epoxy resin utilized can include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

Examples of epoxy resins include epoxy resins of dihydroxy phenols, epoxy resins of biphenols, epoxy resins of bisphenols, epoxy resins of halogenated bisphenols, epoxy resins of alkylated bisphenols, epoxy resins of trisphenols, epoxy resins of phenol-aldehyde novolac resins, epoxy resins of halogenated phenol-aldehyde novolac resins, epoxy resins of alkylated phenol-aldehyde novolac resins, epoxy resins of hydrocarbon-phenol resins, epoxy resins of hydrocarbon-halogenated phenol resins, epoxy resins of hydrocarbon-alkylated phenol resins, or combinations thereof. Illustrative, but non-limiting, examples of an epoxy resin can include, but are not limited to: Epikote Resin 1001 epoxy resin (epoxy resin based on bisphenol A); Epikote Resin 1004 epoxy resin (epoxy resin based on bisphenol A); Epikote Resin 1007 epoxy resin (epoxy resin based on bisphenol A); Epikote Resin 1009 epoxy resin (epoxy resin based on bisphenol A); Epon Resin SU8 epoxy resin (epoxidized bisphenol A novolac); Epon Resin 1031 epoxy resin (epoxidized glyoxal-phenol novolac); Epon Resin 1163 epoxy resin (epoxy resin based on tetrabromobisphenol A); Epikote Resin 03243/LV epoxy resin (epoxy resin based on (3,4-epoxycyclohexyl)methyl 3,4-epoxycyclohexylcarboxylate and bisphenol A); and Epon Resin 164 epoxy resin (epoxidized o-cresol novolac). Each of these epoxy resins are commercially available from Westlake Epoxy Inc.

In at least one embodiment, an epoxy resin is selected from the group consisting of a difunctional bisphenol-A-diglycidyl-ether, a bisphenol-F-diglycidyl-ether, a tetra-glycidyl-methylene-dianiline, an epoxidized tetra-phenylethane, a derivative thereof, and combinations thereof. In some embodiments, the aromatic epoxy resin is derived from a compound comprising bisphenol A, bisphenol F, tetraglycidyl-methylenedianiline, terephthalic acid, phthalic acid, hexahydrophthalic acid, halogenated bisphenol, novolac, ortho-aminophenol, para-aminophenol, flourenone bisphenol, dicyclopentadiene, and combinations thereof.

Other illustrative, but non-limiting, examples of epoxy resins include but are not limited to: Epikote Resin 828 epoxy resin (a difunctional bisphenol-A-diglycidyl-ether); Epikote Resin 862 epoxy resin (a difunctional bisphenol-F-diglycidyl-ether); Epikote Resin 828LVEL epoxy resin (a difunctional bisphenol-A-diglycidyl-ether), Epikote Resin 162 epoxy resin (a bisphenol-A-diglycidyl-ether), Epikote Resin 158 epoxy resin (a bisphenol-F-diglycidyl-ether), Epikote Resin 496 epoxy resin (a tetra-glycidyl-methylene-dianiline), Epikote Resin 1031 epoxy resin (an epoxidized tetra-phenylethane). Each of these epoxy resins are commercially available from Westlake Epoxy Inc.

Epoxy resins can be used alone or in a mixture with other epoxy resins. For example, a blend of a difunctional bisphenol-A-diglycidyl-ether epoxy resin and a difunctional bisphenol-F-diglycidyl-ether epoxy resin, such as a blend of Epikote Resin 828 epoxy resin and Epikote Resin 862 epoxy resin can be utilized in an epoxy resin composition described herein.

A total amount of epoxy resin(s) in epoxy resin compositions described herein can be from about 5 wt % to about 97.45 wt %, such as from about 16 wt % to about 93.23 wt % such as from about 40 weight percent (wt %) to about 95 wt %, such as from about 45 wt % to about 90 wt %, such as from about 50 wt % to about 85 wt %, such as from about 55 wt % to about 80 wt %, such as from about 60 wt % to about 75 wt %, such as from about 65 wt % to about 70 wt %, such as about 65.5 wt %, or from about 45 wt % to about 85 wt %, such as from about 55 wt % to about 75 wt %, such as from about 60 wt % to about 70 wt %, such as from about 62 wt % to about 68 wt %, such as from about 64 wt % to about 66 wt % based on a total weight percent of the epoxy resin composition, though other amounts are contemplated. Any of the foregoing numbers can be used singly to describe an open-ended range or in combination to describe a close-ended range.

Compositions described herein further include a curing agent. Curing agents are also referred to as hardeners. The curing agent can be a catalytic curing agent or a non-catalytic curing agent. Combinations or blends, in any suitable proportions, of curing agents can be utilized for compositions described herein. Suitable curing agents can include those curing agents comprising an amine terminated polyamine. Illustrative, but non-limiting, examples of such curing agents can include diethylene triamine, triethylene tetramine, isophoronediamine, m-xylenediamine, polyetheramine, or combinations thereof. Isophorone diamine is 3-(aminomethyl)-3,5,5-trimethylcyclohexan-1-amine (CAS No.: 2855-13-2) and can be commercially obtained from Evonik Operations GmbH. Polyetheramines may include amines having repeating oxypropylene units of the Formula (I):

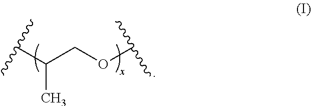

wherein x in Formula (I) can be from about 1 to about 100, such as from about 2 to about 40, such as from about 5 to about 35, such as from about 6 to about 33.

For polyetheramines, these oxypropylene structures are functionally terminated with primary amine groups positioned on secondary carbon atoms. Such polyetheramines are commercially available from Huntsman Corporation as, Jeffamine D-230 polyetheramine, Jeffamine D-400 polyetheramine, Jeffamine D-2000 polyetheramine, and Jeffamine T-403 polyetheramine which are represented by Formula (II):

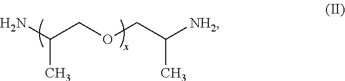

wherein: x in Formula (II) is about 2.5 (Jeffamine D-230 polyetheramine); or x in Formula (II) is about 6.1 (Jeffamine D-400 polyetheramine); or x in Formula (II) is about 33 (Jeffamine D-2000 polyetheramine) or represented by Formula (III):

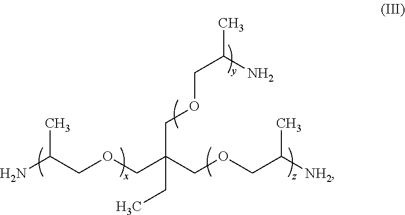

wherein: x+y+z in Formula (III) is 5-6, such as about 5.3 (Jeffamine T-403 polyetheramine).

Jeffamine D-230 polyetheramine is a difunctional primary amine with an average molecular weight of about 230 g/mol, Jeffamine D-400 polyetheramine is a difunctional primary amine with an average molecular weight of about 430 g/mol, Jeffamine D-2000 polyetheramine is a difunctional primary amine with an average molecular weight of about 2,000 g/mol, and Jeffamine T-403 polyetheramine is a trifunctional primary amine with an average molecular weight of about 440 g/mol.

Another polyetheramine that may be used with epoxy resin compositions described herein includes Jeffamine XTJ 568 commercially available from Huntsman Corporation. Jeffamine XTJ 568 is a reaction mass of 1-[2-(2-aminobutoxy) ethoxy]but-2-ylamine and 1-({[2-(2-aminobutoxy) ethoxy]methyl}propoxy) but-2-ylamine (CAS-No.: 897393-42-9).

Other suitable curing agents include amine terminated polyamides. Useful amine terminated polyamides include those prepared by reacting a long-chain dicarboxylic acid such as a dimerized fatty acid (“dimer acids”) or adducts of acrylic and methacrylic acid with unsaturated fatty acids (“adduct acids”) with polyamines under conditions effective to produce a liquid amine terminated polyamine. The resultant polyamines have a number-average amine hydrogen functionality of above 1.7 and up to 4. The polyamide can have an amine plus acid number greater than about 250, an excess of amine groups over acid groups, or combinations thereof.

The amine terminated polyamides may be prepared by thermal condensation of the polyamine, such as in excess, with one or more long-chain dicarboxylic acids or their esters under conditions effective to produce an amine terminated polyamides. Generally the reaction may be carried out at a temperature gradually climbing to a level of above about 200° C., such as at a final temperature within a range from about 220° C. to about 260° C. for a time effective to produce a liquid reaction product, followed by distillation, preferably under vacuum, to remove excess unreacted amine, as well as water and/or alcohol reaction product. These amine terminated polyamides may have a number average molecular weight that is from about 400 g/mol to about 3,000 g/mol, such as from about 700 to about 2000. Alternatively, the amine may be reacted with a chloride of the dicarboxylic acid. The long-chain dicarboxylic acid can be a dicarboxylic acid having from 18 to 50 carbon atoms, such as from 30 to 40 carbon atoms.

As used herein, and unless specified to the contrary or the context clearly indicates otherwise, “dimer acids” refers to polymeric or oligomeric fatty acids typically made from addition polymerization, using heat and a catalyst, of unsaturated fatty acids, such as tall oil fatty acids. These fatty acids may include up to about 20% monobasic acids, about 45% to about 95% dibasic acids, and about 1% to about 35% of tribasic and higher polymeric acids. The relative ratios of monomer, dimer, trimer and higher polymer in unfractionated dimer acid are dependent on the nature of the starting material and the conditions of polymerization and distillation. Examples of the “adduct acids” include adducts of acrylic acid, methacrylic acid, crotonic acid, linoleic acid, soybean oil fatty acid, and tall oil fatty acid, among others. These adducts may be prepared by thermal reaction at temperatures of about 200° C. or more. Examples of polyamines can include aliphatic amines such as, but not limited to, triethylaminetetramine (TETA), ethylenediamine, diethylenetriamine, or combinations thereof.

To produce an amine terminated polyamide curing agent, one may use a starting ratio of moles of polyamine to equivalents of carboxyl group in the acid or acid mixture used of greater than 0.75:1, such as greater than 0.9:1, such as greater than 1:1. Alternatively, the amine terminated polyamine curing agent can be prepared by reacting one or more polyamines with one or more long-chain dicarboxylic acids and optionally one or more other dicarboxylic acids. Such other dicarboxylic acid can be any suitable dicarboxylic acid having carbon numbers from 4 to 20, which can be a long-chain or not a long-chain dicarboxylic such as, for example, azelaic acid, sebacic acid and adipic acid. A minor amount (up to about 25% of total carboxyl equivalents) of a monocarboxylic acid such as tall oil fatty acid may also be included as a chain terminator.

Illustrative, but non-limiting, examples of amine terminated polyamides include Epikure Curing Agent 3140B (a multifunctional polyamidoamine curing agent (CAS No.: 68082-29-1)); Epikure Curing Agent 3072 (an amidoamine curing agent).

Additionally, or alternatively, suitable curing agents can include, but are not limited to, an imidazole, a substituted imidazole, an imidazole adduct, an imidazole complex (for example, Ni-imidazole complex), a tertiary amine, a quaternary ammonium compound, a quaternary phosphonium compound, a dicyandiamide, a salicylic acid, urea, a urea derivative, a boron trifluoride complex, a boron trichloride complex (for example, boron trichloride alkylalmine complex, an epoxy addition reaction product, a tetraphenylene-boron complex, an amine borate, a metal halide, an amine titanate, a metal acetylacetonate, a naphthenic acid metal salt, an octanoic acid metal salt, other metal salts, metal chelates, or combinations thereof. Curing agents can include, for example, boron trichloride dimethyloctylamine complex (CAS No. 34762-90-8), oligomeric polyethylenepiperazines, bis-(dimethylaminopropyl)-amino-2-propanol, N,N′-bis-(3-dimethylaminopropyl) urea, N-(2-hydroxypropyl) imidazole, dimethyl-2-(2-aminoethoxy) ethanol, bis(2-dimethylaminoethyl) ether, pentamethyldiethylenetriamine, dimorpholinodiethyl ether, 1,8-diazobicyclo [5.4.0]undec-7-ene (DBU) (CAS No. 6674-22-2, commercially available from BASF), N-methylimidazole (also known as 1-methylimidazole (CAS No. 616-47-7), commercially available from BASF), 1,2-dimethylimidazole, methyl nadic anhydride (also known as methyl-5-norbornene-2,3-dicarboxylic anhydride; CAS No. 25134-21-8, commercially available from Polynt), triethylenediamine, 1,1,3,3-tetra-methylguanidine, tin (IV) chloride, tin octoate, or combinations thereof.

In some examples, the curing agent is anhydride free, acid anhydride free, or combinations thereof. Anhydrides and acid anhydrides can be a concern due to their respiratory-sensitizing effects.

A total amount of curing agent(s) in epoxy resin compositions described herein can be from about 2 wt % to about 50 wt %, such as from about 2 wt % to about 40 wt %, such as from about 3 wt % to about 38 wt %, such as from about 5 wt % to about 35 wt %, such as from about 10 wt % to about 30 wt %, such as from about 15 wt % to about 25 wt %, such as from about 20 wt % to about 25 wt %, or from about 15 wt % to about 35 wt %, such as from about 20 wt % to about 30 wt %, such as from about 22 wt % to about 28 wt %, such as from about 24 wt % to about 26 wt %, such as about 24.6 wt %, or from about 12 wt % to about 36 wt %, such as from about 15 wt % to about 33 wt %, such as from about 18 wt % to about 30 wt %, such as from about 21 wt % to about 27 wt %, such as from about 23 wt % to about 25 wt % based on a total weight percent of the epoxy resin composition, though other amounts are contemplated. Any of the foregoing numbers can be used singly to describe an open-ended range or in combination to describe a close-ended range.

Compositions described herein further include an impact modifier. Impact modifiers are also referred to as tougheners. Impact modifiers can serve to improve fracture toughness. Any suitable impact modifier can be utilized. The impact modifier can be derived from any suitable compound such methacrylate, methyl methacrylate, butadiene, styrene, acrylate, vinyl chloride, acrylonitrile, urethane, amide, etherester, olefin, propylene, ethylene, a siloxane, copolymers thereof, or combinations thereof. The impact modifier may be functionalized with silicone.

The impact modifier can include polyvinylchloride, methyl methacrylate butadiene styrene, polybutadiene, butadiene-acrylic copolymer, polybutadiene-polymethacrylate block copolymer, polysiloxane, polybutylacrylate, polymer modifier with a linear structure based on a functionalized silicone, polybutylacrylate, copolymers thereof, or combinations thereof. In some examples, the impact modifier comprises a methyl methacrylate butadiene styrene rubber, a polybutadiene core shell rubber, a butadiene-acrylic copolymer, a polybutadiene-polymethacrylate block copolymer, a polyvinylchloride, a block copolymer with silicone and organic blocks (the organic blocks, for example, being based on caprolactone or other lactones), a polysiloxane core-shell impact modifier, a polybutylacrylate core-shell rubber, a functionalized silicone, a silicone-containing block copolymer, a polymer modifier with a linear structure based on a functionalized silicone, copolymers thereof, or combinations thereof.

Illustrative, but non-limiting, examples of impact modifiers can include: Paraloid TMS-2670J; Kane Ace MX154; Kane Ace MZ110; Clearstrength XT 151; Genioperl W35; and Albidur EP XP 2230. Paraloid TMS-2670J is a methyl methacrylate butadiene styrene (MBS) core shell rubber impact modifier commercially available from Dow Chemical Company. Kane Ace MX154 is a polybutadiene core shell rubber impact modifier commercially available from Kaneka Belgium NV. Kane Ace MZ110 is a butadiene-acrylic copolymer impact modifier commercially available from Kaneka Belgium NV. Clearstrength XT 151 is a polybutadiene-polymethacrylate block copolymer impact modifier commercially available from Arkema. Genioperl W35 is a polymer modifier with a linear structure based on a functionalized silicone commercially available from Wacker Chemie AG, Munich, Germany. Albidur EP XP 2230 is a polybutylacrylate core-shell rubber impact modifier commercially available from Evonik Industries. Albidur EP 2240 A is a polysiloxane core-shell impact modifier commercially available from Evonik Industries.

A total amount of impact modifier(s) in epoxy resin compositions described herein can be from greater than 0 wt % to about 25 wt %, such as from about 0.5 wt % to about 20 wt %, such as from about 0.6 wt % to about 18 wt %, such as from about 0.7 wt % to about 15 wt %, such as from about 0.9 wt % to about 10 wt %, such as from about 1 wt % to about 6 wt %, such as from about 1.5 wt % to about 5 wt %, such as from about 1.8 wt % to about 3 wt %, such as from about 2 wt % to about 2.5 wt %, such as about 2.2 wt %, or from greater than 0 wt % to about 5 wt %, such as from about 0.5 wt % to about 4 wt %, such as from about 1 wt % to about 3 wt %, such as from about 1.5 wt % to about 2.5 wt %, such as from about 2.0 wt % to about 2.3 wt % based on a total weight percent of the epoxy resin composition, though other amounts are contemplated. Any of the foregoing numbers can be used singly to describe an open-ended range or in combination to describe a close-ended range.

Epoxy resin compositions described herein further include one or more first fillers. The first filler has a density of greater than 0.2 g/cm³, greater than about 0.5 g/cm³, greater than about 1.0 g/cm³, greater than about 1.5 g/cm³, greater than about 2.0 g/cm³, greater than about 2.5 g/cm³, less than about 2.8 g/cm³, or combinations thereof, such as from 0.2 g/cm³ to about 2.8 g/cm³, such as from about 0.5 g/cm³ to about 2.6 g/cm³, such as from about 1.0 g/cm³ to about 2.4, such as from about 1.5 g/cm³ to about 2.2 g/cm³, such as from about 1.6 g/cm³ to about 2.0 g/cm³, though other values are contemplated. Any of the foregoing numbers can be used singly to describe an open-ended range or in combination to describe a close-ended range. As further described below, epoxy resin compositions described herein further include a second filler. The first filler has a density that is greater than the second filler.

Illustrative, but non-limiting, examples of first fillers include silica, fumed silica, wollastonite (CaSiO₃ that may contain small amounts of iron, magnesium, and manganese), quartz, alumina, aluminum nitride (AlN), boron nitride (BN), silicon nitride (SiN), silicon carbide (SiC), beryllium oxide (BeO), glass fibers, or combinations thereof, with each of these materials having a density of greater than 0.2 g/cm³. Ceramic materials that have a density of greater than 0.2 g/cm³, in general, can be used. Inorganic fillers that have a density of greater than 0.2 g/cm³, in general, can be utilized. Other fillers that have a density of greater than 0.2 g/cm³ are contemplated.

In at least one embodiment, the first filler includes quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, basalt, magnesium carbonate, magnesium sulfate, barium sulfate, polydimethylsiloxane pre-treated fumed silica, hydrophilic silane pretreated silica, chemithermomechanical pulp, epoxy-silane pre-treated silica, epoxy-silane pre-treated wollastonite, or combinations thereof, with each of these materials having a density of greater than 0.2 g/cm³.

The first filler can include particles that are coated with a silane, a siloxane, a silicone, an epoxysilane, a methylsiloxane, a methacrylic silane, or a mixture thereof.

In some examples, the first filler includes: a polydimethylsiloxane pre-treated material, such as a polydimethylsiloxane pre-treated version of the aforementioned fillers, such as a polydimethylsiloxane pre-treated fumed silica; or a hydrophilic silane pre-treated material, such as a hydrophilic silane pre-treated version of the aforementioned fillers, such as a hydrophilic silane pre-treated fumed silica; an epoxy-silane pre-treated material, such as an epoxy-silane pre-treated version of the aforementioned fillers, such as epoxy-silane pre-treated silica or epoxy-silane pre-treated wollastonite; or combinations thereof.

Non-limiting examples of epoxysilane pre-treated silica filler include Millisil W12 EST and Millisil SF 600 EST, both commercially available from Quarzwerke Group. A non-limiting example of an epoxysilane pre-treated wollastonite filler is Tremin 283-100 EST commercially available from Quarzwerke Group. Non-limiting examples of commercially available quartz-type fillers include Sikron SF300, Sikron SF 600, Sikron SF 800, Millisil SF 600 EST, and Amosil FW 600 from Quarzwerke GmbH (50226 Frechen, Germany); and Mikro-Dorsilit 120 from Quarzsande GmbH (4070 Eferding, Austria).

An illustrative, but non-limiting, example of a polydimethylsiloxane pre-treated fumed silica includes Cab-o-sil TS-720 (density of 2.2 g/cm³) and commercially available from Cabot Corporation. An illustrative, but non-limiting, example of a hydrophilic silane pre-treated fumed silica includes HDK N20 (density of 2.2 g/cm³) and commercially available from Wacker Chemie AG. An illustrative, but non-limiting, example of a glass fiber filler includes FG 400/060 (a filler based on milled E-glass fibers; density of 2.55 g/cm³ to 2.66 g/cm³; an average fiber length of 230 μm; and a fiber diameter of 9 μm to 14 μm) which is commercially available from Schwarzwälder Textil-Werke Heinrich Kautzmann GmbH. An illustrative, but non-limiting, example of a chemithermomechanical pulp includes Filtracel EFC 450 (a chemithermomechanical pulp and a density of 1.5 g/cm³) which is commercially available from J. Rettenmaier & Söhne GmbH+CoKG.

Combinations or blends of first fillers, in any suitable proportions, can be utilized for compositions described herein. Such combinations can include more than one type of first filler.

A total amount of the first filler(s) in epoxy resin compositions described herein can be greater than 0 wt %, about 30 wt % or less, or combinations thereof, such as from greater than 0 wt % to about 25 wt % or less, or from 1 wt % to about 30 wt %, such as from about 1 wt % to about 20 wt %, such as from about 2 wt % to about 15 wt %, such as from about 4 wt % to about 10 wt %, such as from about 5 wt % to about 9 wt %, such as from about 6 wt % to about 8 wt %, such as from about 7 wt % to about 8 wt %, such as about 7.4 wt %, or from about 1 wt % to about 13 wt %, such as from about 3 wt % to about 11 wt %, such as from about 5 wt % to about 10 wt %, such as from about 6 wt % to about 8 wt %, or from about 3 wt % to about 25 wt %, such as from about 3.5 wt % to about 20 wt %, such as from about 4 wt % to about 15 wt %, such as from about 4.5 wt % to about 8.5 wt %, such as from about 5 wt % to about 8 wt %, based on the total wt % of the epoxy resin composition, though other amounts are contemplated. Any of the foregoing numbers can be used singly to describe an open-ended range or in combination to describe a close-ended range.

Compositions described herein further include one or more second fillers. In contrast to the first fillers, the second fillers are low density fillers, having a lower density than that of the first fillers. As used herein, the term “low density” when describing a filler can refer to any suitable filler material that has a density of 0.2 g/cm³ or less.

The use of the second filler, having a lower density than the first filler, can enable a manufacturer to reduce the weight of the component or part (such as a component or part of a wind turbine), while maintaining required mechanical characteristics and durability. Combinations of second fillers can be utilized, in any suitable proportions, if desired.

In some embodiments, a density of the second filler is 0.2 g/cm³ or less, greater than 0 g/cm³, or combinations thereof, such as about 0.15 g/cm³ or less, such as about 0.1 g/cm³ or less, such as about 0.08 g/cm³ or less, such as about 0.06 g/cm³ or less, such as about 0.05 g/cm³ or less, such as about 0.04 g/cm³ or less, such as about 0.03 g/cm³ or less, though other values are contemplated. Any of the foregoing numbers can be used singly to describe an open-ended range or in combination to describe a close-ended range. In at least one embodiment, the density of the second filler is from greater than 0 g/cm³ to 0.2 g/cm³, such as from about 0.01 g/cm³ to about 0.15 g/cm³, such as from about 0.02 g/cm³ to about 0.1 g/cm³, such as from about 0.03 g/cm³ to about 0.08 g/cm³, though other values are contemplated. Any of the foregoing numbers can be used singly to describe an open-ended range or in combination to describe a close-ended range.

The second filler can include any suitable material such as a thermoplastic having a density of 0.2 g/cm³ or less. The thermoplastic can be derived from any suitable compound such as acrylonitrile, urethane, amide, etherester, olefin, propylene, ethylene, styrene, methacrylate, methyl methacrylate, vinyl chloride, vinylidene chloride, copolymers thereof, or combinations thereof, and having a density of 0.2 g/cm³ or less. The thermoplastic can include polyacrylonitrile, polyurethane, polyamide, polyetherester, polyolefin, polypropylene, polyethylene, polystyrene, polymethacrylate, polymethylmethacrylate, copolymers thereof, or combinations thereof, and having a density of 0.2 g/cm³ or less.

The second filler can be at least partially hollow, include voids, or combinations thereof. The second filler can include a core-shell particle, where the core is at least partially hollow, has voids, or combinations thereof. The shell can include a thermoplastic such as those described above.

The second filler, having a density of 0.2 g/cm³ or less, can include materials that are chemically treated to, for example, increase its hydrophobicity, for instance but without limitation by applying a silane, a siloxane, a silicone coating, or a mixture thereof to the materials.

In at least one embodiment, the second filler includes an expandable thermoplastic such as an expandable thermoplastic microsphere having a density of 0.2 g/cm³ or less. Thermoplastic microspheres can include a thermoplastic shell containing a volatile propellant. The thermoplastic microsphere having a density of 0.2 g/cm³ or less can be produced by any suitable method such as by suspension polymerization where a liquid monomer or monomer mixture containing condensed propellant is dispersed in an aqueous medium containing suspending agent and polymerization catalyst. The resulting microspheres include a polymer shell containing the liquid, volatile propellant. The spheres expand by heating to a temperature above the boiling point of the propellant and the softening point of the polymer. The thermoplastic shell of the spheres may include polymers or copolymers of acrylonitrile, urethane, amide, etherester, olefin, propylene, ethylene, styrene, methacrylate, methylmethacrylate, vinyl chloride, vinylidene chloride, copolymers thereof, or combinations thereof. The propellant of the thermoplastic microsphere can be any suitable propellant such as: halocarbons, such as freon, and trichlorofluoromethane; hydrocarbons, such as n-pentane, iso-pentane, neopentane, butane, iso-butane; or other suitable propellants. The propellant may make up about 5% to about 30% by weight of the microsphere.

A particle size (D(0.5)) of the thermoplastic microsphere can be any suitable particle size such as from about 1 μm to about 1 mm, such as from about 2 μm to about 500 μm, such as from about 5 μm to about 250 μm, such as from about 10 μm to about 100 μm, such as from about 20 μm to about 80 μm, such as from about 35 μm to about 55 μm, though other amounts are contemplated. Any of the foregoing numbers can be used singly to describe an open-ended range or in combination to describe a close-ended range.

Examples of commercially available second fillers having a density of 0.2 g/cm³ or less include those available from Nouryon such as the Expancel DE series, Expancel FG series, Expancel WE series, and Expancel DU series, and having a density of 0.2 g/cm³ or less. Illustrative, but non-limiting, second fillers that can be used include the following microspheres available from Expancel: 920 DET 20 d40, 920 DE 40 d30, 920 DET 40 d25, 920 DE 80 d30, HP92 DET 80 d45, 043 DET 80 d20, 920 DE 20 d70, 044 DET 40 d25, 044 DET 40 d40, 031 DU 40, 053 DU 40, 051 DU 40, 043 DU 80, 920 DU 20, 920 DU 40, 909 DU 80, 920 DU 80, HP92 DU 80, 950 DU 80, 093 DU 120, 951 DU 120, 930 DU 120, 920 DU 120, 980 DU 100, 044 DU 20, 044 DU 40, 920 WE 40 d24, 921 WE 40 d24, 044 WE 20 d36, or combinations thereof. These Expancel products comprise expandable thermoplastic microspheres.

Other examples of second fillers include Advancell thermoplastic microspheres commercially available from Sekisu Chemical Co., Ltd, and having a density of 0.2 g/cm³ or less, such as EML101, EMH204, EHM302, EHM303, EM306, EM403, EM406, EM501, EM504, or combinations thereof. These Advancell products comprise expandable thermoplastic microspheres that typically include ethylene/methyl methacrylate (EMMA), low density polyethylene (LDPE), acrylonitrile, or copolymers thereof.

Other examples of second fillers include Matsumoto Microsphere F series, F-E series, F-DE series, and FN series commercially available from Matsumoto Yushi-Seiyaku Co., Ltd., and having a density of 0.2 g/cm³ or less, such as F-36, DN-80GS, FN-100SS, F-100M, FN-100M, FN-180, F-190D, or combinations thereof. These Matsumoto microsphere products comprise expandable thermoplastic microspheres that typically include acrylonitrile or copolymers thereof.

In at least one embodiment, the second filler includes Expancel 920 DE 40 d30. Expancel 920 DE 40 d30, an acrylonitrile copolymer, has a density of 0.03 g/cm³ and a particle size D (0.5) from 35 μm to 55 μm.

Combinations or blends of second fillers, in any suitable proportions, can be utilized for compositions described herein. Such combinations can include more than one type of second filler.

A total amount of second filler(s) in epoxy resin compositions described herein can be greater than 0 wt %, less than about 20 wt %, or combinations thereof, such as from about 0.01 wt % to about 10 wt %, such as from about 0.01 wt % to about 5 wt %, such as from about 0.05 wt % to about 5 wt %, such as from about 0.07 wt % to about 4 wt %, such as from about 0.1 wt % to about 3 wt %, such as from about 0.2 wt % to about 2 wt %, such as from about 0.25 wt % to about 1.5 wt %, such as from about 0.3 wt % to about 1 wt %, such as from about 0.3 wt % to about 0.5 wt %, 0.4 wt % to about 0.5 wt %, or from about 0.25 wt % to about 0.35 wt %, though other amounts are contemplated. Any of the foregoing numbers can be used singly to describe an open-ended range or in combination to describe a close-ended range.

A total amount of the first filler and the second filler in epoxy resin compositions described herein can be greater than 0 wt %, less than about 50 wt %, or combinations thereof, such as from about 0.05 wt % to about 48 wt %, such as from about 0.5 wt % to about 45 wt %, such as from about 1 wt % to about 40 wt %, such as from about 2 wt % to about 35 wt %, such as from about 4 wt % to about 30 wt %, such as from about 7 wt % to about 27 wt %, such as from about 9 wt % to about 25 wt %, such as from about 11 wt % to about 23 wt %, such as from about 13 wt % to about 21 wt %, such as from about 15 wt % to about 19 wt %, such as about 17 wt % based on the total wt % of the epoxy resin composition, though other amounts are contemplated. Any of the foregoing numbers can be used singly to describe an open-ended range or in combination to describe a close-ended range. Other amounts are contemplated.

A weight ratio of the first filler to the second filler can be from about 1:1 to about 80:1, such as from about 3:1 to about 60:1, such as from about 5:1 to about 50:1, such as from about 10:1 to about 45:1, such as from about 15:1 to about 30:1, such as from about 20:1 to about 25:1, such as about 24:1, though other values are contemplated. Any of the foregoing numbers can be used singly to describe an open-ended range or in combination to describe a close-ended range.

Suitable epoxy resin compositions can include one or more of the following:
(a) an amount of the epoxy resin that is from a lower end amount to a higher end amount, inclusive, where the lower end amount can be about 5 wt %, or about 16 wt %, or about 40 wt %, or about 45 wt % and the higher end amount can be about 95 wt %, or about 93.23 wt %, or about 90 wt %, or about 85 wt % based on a total wt % of the epoxy resin composition, the total wt % of the epoxy resin composition is 100 wt %, though other values are contemplated;
(b) an amount of the impact modifier that is from a lower end amount to a higher end amount, inclusive, where the lower end amount can be greater than 0 wt %, or about 0.5 wt %, or about 0.7 wt % and the higher end amount can be about 20 wt %, or about 15 wt %, or about 5 wt % based on the total wt % of the epoxy resin composition, though other values are contemplated;
(c) an amount of the curing agent that is from a lower end amount to a higher end amount, inclusive, where the lower end amount can be about 2 wt %, or about 3.23 wt %, or about 12 wt % and the higher end amount can be about 50 wt %, or about 40 wt %, or about 36 wt % based on the total wt % of the epoxy resin composition, though other values are contemplated;
(d) an amount of the first filler that is from a lower end amount to a higher end amount, inclusive, where the lower end amount can be from greater than 0 wt %, or about 1 wt %, or about 2.45 wt %, or about 3 wt % and the higher end amount can be about 30 wt %, or about 25 wt %, or about 13 wt % based on the total wt % of the epoxy resin composition, though other values are contemplated;
(e) an amount of the second filler that is from a lower end amount to a higher end amount, inclusive, where the lower end amount can be about 0.01 wt %, or about 0.05 wt %, or about 0.07 wt % and the higher end amount can be about 5 wt % or about 4 wt % based on the total wt % of the epoxy resin composition, though other values are contemplated; or
(f) combinations thereof.

Besides the epoxy resin, the curing agent, the impact modifier, the first filler, and the second filler, epoxy resin compositions described herein can optionally include additives. Illustrative, but non-limiting, examples of optional additives can include, or are selected from the group consisting of, a modifier (for example, a viscosity modifier), a colorant, a wetting and dispersing additive, surface additive, rheology additive, a defoamer, an air release additive, an adhesion promoter, a coupling agent, a processing additive, or combinations thereof. The optional additives can be used to aid in processing, to improve fracture toughness, to improve strength, among other uses.

A total amount of optional additive(s) in compositions described herein can be from about 0 wt % to about 10 wt %, such as from about 0.01 wt % to about 10 wt %, such as from about 0.1 wt % to about 9 wt %, such as from about 0.5 wt % to about 7 wt %, such as from about 1 wt % to about 5 wt %, such as from about 2 wt % to about 3 wt %, or from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Suitable modifiers include viscosity modifiers such as glycidyl ethers. Suitable glycidyl ethers can include diglycidyl ether of 1,6-hexanediol, alkyl C12-C14 glycidyl ether, butyl glycidyl ether, 2-ethylhexyl glycidyl ether, cresyl glycidyl ether, or p-tert-butyl phenyl glycidyl ether. A non-limiting example of a glycidyl ether can include Heloxy Modifier HD (a viscosity modifier comprising a diglycidyl ether of 1,6-hexanediol commercially available from Westlake Epoxy Inc.) and Heloxy Modifier 61 (a viscosity modifier comprising butyl glycidyl ether commercially available from Westlake Epoxy Inc. The modifier may also serve as a reactive or non-reactive diluent. In at least one embodiment, compositions described herein can include a modifier, wherein the modifier is a glycidyl ether.

A total amount of modifier(s) such as monohydric alcohols, polyhydric alcohols, or combinations thereof in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Wetting and dispersing additives can be utilized in epoxy resin compositions described herein to improve the wetting of solids and to prevent particles from flocculating. Non-limiting examples can include Byk-W 903 or Byk-W 909 which are commercially available from BYK-Chemie GmbH. Byk-W 903 is a wetting and dispersing additive that can be used with filled epoxide systems. Byk-W 909 is a wetting and dispersing additive that can be used to reduce the viscosity in highly filled UP casting resin systems. Combinations of wetting and dispersing additives can be used.

A total amount of wetting and dispersing additive(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Surface additives can be utilized in epoxy resin compositions described herein to minimize surface defects caused by, e.g., differences in surface tension, during application of epoxy resin composition. Non-limiting examples of surface additives can include Byk-306 or Byk-390 which are commercially available from BYK-Chemie GmbH. Byk-306 is a silicone-containing surface additive, and Byk-390 is a polyacrylate based surface additive. Combinations of surface additives can be used.

A total amount of surface additive(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Rheology additives can be utilized in epoxy resin compositions described herein to adjust the rheological profile of the epoxy resin composition. Non-limiting examples of rheology additives can include Garamite-7303 or Claytone-34 which are commercially available from commercially available from BYK-Chemie GmbH. Garamite-7303 is a powdered rheology additive for non-polar to medium-polar solvent-borne and solvent-free systems to increase the storage stability and sag resistance. Claytone-34 is a rheology additive based on montmorillonite for solvent-borne systems. Combinations of rheology additives can be used.

A total amount of rheology additive(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Defoamers and air release agents can be utilized in epoxy resin compositions described herein to reduce the amount of bubbling in the compositions, for example, to remove gaseous impurities. Non-limiting examples of defoamers and air release agents can include Byk-054 T, Byk-073, Byk S732, Byk-A 500, Byk-A 50, Byk-A 515, Byk 390, Byk 306, Byk 315, or Byk 356, each of which are commercially available from BYK-Chemie GmbH; or Silfar S184 available from Wacker Chemie AG. Byk-054 T is a silicone-free defoamer on polymer basis for solvent-borne and solvent-free systems. Byk-073 is a silicone-containing defoamer for solvent-borne systems. Combinations of defoamers and air release agents can be utilized.

A total amount of defoamer(s) and air release agent(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Adhesion promoters and coupling agents can be utilized in epoxy resin compositions described herein to positively influence the adhesion of compositions on a substrate, the tolerance towards of surface impurities, and the resistance to moisture and corrosion. Non-limiting examples of adhesion promoters and coupling agents can include Byk-4511 or Byk-C 8001 which are commercially available from BYK-Chemie GmbH. Byk-4511 is a polymeric adhesion promoter for solvent-free and solvent-borne (also high solid) two-pack epoxy resin systems and baking systems. Byk-C 8001 is a polymeric coupling agent for increasing the mechanical strength of epoxy resin systems. Combinations of adhesion promoters and coupling agents can be utilized.

A total amount of adhesion promoter(s) and coupling agent(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Processing additives can be utilized in epoxy resin compositions described herein to adjust flow behavior of the compositions. Non-limiting examples of processing additives can include Byk-P 2710 or Byk-P 9920 which are commercially available from BYK-Chemie GmbH. Byk-P 2710 is a processing additive for solvent-free and solvent-borne epoxy resins for the adjustment of rheological properties. Byk-P 9920 is a processing additive for improving the fiber wetting in composites. Combinations of processing additives can be utilized.

A total amount of processing additive(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Colorants can be utilized in epoxy resin compositions described herein. Illustrative, but non-limiting, examples of colorants can include magnesium oxide Sudan Yellow 146 (commercially available from John Hogg Technical Solutions Ltd.) and Sudan Blue 670 (commercially available from BASF SE). Combinations of colorants can be used. A total amount of colorant(s) in epoxy resin compositions described herein can be from 0 wt % to about 2 wt %, such as from about 0.005 wt % to about 1.995 wt %, such as from about 0.01 wt % to about 1.99 wt %, such as from about 0.05 wt % to about 1.95 wt %, such as from about 0.1 wt % to about 1.5 wt %, such as from about 0.2 wt % to about 1 wt %, such as from about 0.25 wt % to about 0.5 wt %, or from greater than 0 wt % to about 2 wt %, or from about 0.5 wt % to about 2 wt %, or from about 0.2 wt % to about 0.4 wt % based on the total wt % of the epoxy resin composition, though other amounts are contemplated. Any of the foregoing numbers can be used singly to describe an open-ended range or in combination to describe a close-ended range.

Epoxy resin compositions described herein can have one or more of the following non-limiting properties:
(a) A density (at 20° C.) of epoxy resin compositions described herein can be greater than 1.0 g/cm³, about 1.20 g/cm³ or less, or combinations thereof, such as from 1.0 g/cm³ to about 1.20 g/cm³, such as from 1.0 g/cm³ to 1.15 g/cm³, such as from 1.0 g/cm³ to about 1.10 g/cm³, such as from 1.0 g/cm³ to about 1.08 g/cm³, such as from 1.0 g/cm³ to about 1.07 g/cm³, such as from 1.0 g/cm³ to about 1.06 g/cm³, such as from 1.0 g/cm³ to about 1.05 g/cm³, such as from 1.0 g/cm³ to about 1.04 g/cm³, such as from 1.0 g/cm³ to about 1.03 g/cm³, such as from 1.0 g/cm³ to about 1.02 g/cm³, such as from 1.0 g/cm³ to about 1.01 g/cm³, or from about such as from 1.01 g/cm³ to about 1.12 g/cm³, such as from about 1.02 g/cm³ to about 1.11 g/cm³, such as from about 1.03 g/cm³ to about 1.10 g/cm³, such as from about 1.04 g/cm³ to about 1.09 g/cm³, such as from about 1.05 g/cm³ to about 1.08 g/cm³, such as from about 1.06 g/cm³ to about 1.07 g/cm³, though other values are contemplated. Any of the foregoing numbers can be used singly to describe an open-ended range or in combination to describe a close-ended range. The density of epoxy resin compositions is determined as described in the Examples Section.
(b) A tensile strength (at 23° C.) of epoxy resin compositions described herein can be about 20.0 MPa or more, about 100.0 MPa or less, or combinations thereof, such as from about 20.0 MPa to about 100.0 MPa, such as from about 25 MPa to about 80 MPa, such as from about 30 MPa to about 60 MPa, such as from about 35 MPa to about 55 MPa, such as from about 40 MPa to about 50 MPa, such as from about 46 MPa to about 49 MPa, such as about 47.8 MPa, though other values are contemplated. Any of the foregoing numbers can be used singly to describe an open-ended range or in combination to describe a close-ended range. The tensile strength of epoxy resin compositions is determined as described in the Examples Section.
(c) Tensile strain at break (at 23° C.) of epoxy resin compositions described herein can be about 0.5% or more, about 20.0% or less, or combinations thereof, such as from about 1.0% to about 15.0%, such as from about 2.0% to about 12.0%, such as from about 3.0% to about 11.0%, such as from about 4.0% to about 10.0%, such as from about 5.0% to about 9.0%, such as from about 6.0% to about 8.0%, such as about 6.7%, though other values are contemplated. Any of the foregoing numbers can be used singly to describe an open-ended range or in combination to describe a close-ended range. The tensile strain at break of epoxy resin compositions is determined as described in the Examples Section.
(d) A fracture toughness (at 23° C.) of epoxy resin compositions described herein can be about 500 J/m2 or more, about 800 J/m2 or more, about 1,000 J/m2 or more, about 1,200 J/m2 or more, about 1,400 J/m2 or more, about 1,500 J/m2 or more, about 1,600 J/m2 or more, about 1,800 J/m2 or more, about 2,000 J/m2 or more, about 2,000 J/m2 or more, about 2,200 J/m2 or more, about 2,500 J/m2 or more, or about 5,000 J/m2 or less, about 4,500 J/m2 or less, about 4,000 J/m2 or less, about 3,500 J/m2 or less, or from about 500 J/m2 to about 5,000 J/m2, such as from about 1,000 J/m2 to about 4,500 J/m2, such as from about 1,500 J/m2 to about 4,000 J/m2, such as from about 2,000 J/m2 to about 3,800 J/m2, such as from about 2,500 J/m2 to about 3,500 J/m2, such as from about 2,800 J/m2 to about 3,400 J/m2, such as from about 3,000 J/m2 to about 3,200 J/m2, such as about 3,011 J/m2, though other values are contemplated. Any of the foregoing numbers can be used singly to describe an open-ended range or in combination to describe a close-ended range. The fracture toughness of epoxy resin compositions is determined as described in the Examples Section.
(e) A pot life (at 30° C.) of epoxy resin compositions described herein can be about 30 minutes or more, about 60 minutes or more, about 100 minutes or more, about 120 minutes or more, about 150 minutes or more, about 165 minutes or more, about 170 minutes or more, or about 180 minutes or more, though other values are contemplated. Any of the foregoing numbers can be used singly to describe an open-ended range or in combination to describe a close-ended range. The pot life of epoxy resin compositions is determined as described in the Examples Section.
(f) A glass-transition temperature midpoint of epoxy resin compositions described herein can be about 60° C. or more, about 120° C. or less, or combinations thereof, such as from about 60° C. to about 120° C., such as from about 70° C. to about 110° C., such as from about 80° C. to about 105° C., such as from about 85° C. to about 100° C., such as from about 88° C. to about 95° C., such as about 90° C., though other values are contemplated. Any of the foregoing numbers can be used singly to describe an open-ended range or in combination to describe a close-ended range. The glass-transition temperature midpoint of epoxy resin compositions is determined as described in the Examples Section.

Embodiments described herein also generally relate to methods of making or forming the compositions. In general, epoxy resin compositions described herein can be made or formed by introducing the components (the epoxy resin, the impact modifier, the curing agent, the first filler, the second filler, optional additives, or combinations thereof) of the epoxy resin composition to one another and mixing the components in conventional mixing units, such as intimate mixers or extruders, generally at room temperature.

In some embodiments, the epoxy resin, the impact modifier, the curing agent, the first filler, the second filler, optional additives, or combinations thereof can be charged to a vessel and stirred, mixed, or otherwise agitated under mixing conditions effective to form a composition. Mixing conditions can include using a mixing pressure of about 50 Pa to about 150 kPa, such as from about 5 kPa to about 125 kPa, such as from about 30 kPa to about 110 kPa, such as from about 50 kPa to about 105 kPa, though other pressures are contemplated. Any of the foregoing numbers can be used singly to describe an open-ended range or in combination to describe a close-ended range. Mixing conditions can include elevated temperature if desired. However, if elevated temperatures are used during mixing of the materials, the mixing temperature should be below the temperature at which the curing agent becomes active.

Mixing conditions can include stirring, mixing, agitating, or combinations thereof by using suitable devices such as a mechanical stirrer or high shear mixer. Such mixing conditions can include use of suitable devices such as a mechanical stirrer or high shear mixer such as an overhead stirrer, a magnetic stirrer (for example, placing a magnetic stir bar in the vessel above a magnetic stirrer), or other suitable devices. For example, a stirrer or high shear mixer having a blade or propeller can be rotated by receiving rotational power from a stirring motor to stir the one or more materials at suitable rotation speeds. The stirrer or high shear mixer having a blade or propeller can be rotated by receiving rotational power from a stirring motor to stir the one or more materials at suitable rotation speeds, such as from about 50 revolutions per minute (rpm) to about 5,000 rpm, such as from about 500 rpm to about 4,500 rpm, such as from about 1,000 rpm to about 4,000 rpm, such as from about 1,500 rpm to about 3,500 rpm, or from about 50 rpm to about 1,500 rpm, such as from about 75 rpm to about 1,000 rpm, such as from about 100 rpm to about 900 rpm, such as from about 200 rpm to about 800 rpm, such as from about 300 rpm to about 700 rpm, such as from about 400 rpm to about 600 rpm, such as from about 450 rpm to about 550 rpm, such as about 500 rpm. Any of the foregoing numbers can be used singly to describe an open-ended range or in combination to describe a close-ended range. Other rotation speeds are contemplated and can be selected based on the ability to mix the components sufficiently.

Mixing conditions can include utilizing a non-reactive gas, such as N₂, Ar, or combinations thereof. For example, a non-reactive gas can be introduced to one or more of the epoxy resin, the impact modifier, the curing agent, the first filler, and optional additives to degas various components or otherwise remove unwanted gases such as oxygen from the mixture. Mixing conditions can include mixing for any suitable period, such as from about 1 minute to about 48 hours, such as from about 5 minutes to about 24 hours, such as from about 30 minutes to about 10 hours, such as from about 1 hour to about 5 hours, such as from about 2 hours to about 3 hours, or from about 1 minute to about 30 minutes, such as from about 2 minutes to about 10 minutes, though other periods are contemplated. Any of the foregoing numbers can be used singly to describe an open-ended range or in combination to describe a close-ended range.

At this stage, the epoxy resin composition is formed and can be stored for immediate use, later use, or combinations thereof. In addition, and at this stage, the epoxy resin composition can be a curable epoxy resin composition such that the epoxy resin composition can be cured by application of a stimulus, for example, a change in temperature. The curable composition can be in the form of, for example, a fluid, a paste, a gel, or a viscous substance at ambient conditions (for example, room temperature (about 15° C. to about 25° C.)). If the epoxy resin composition is to be curable, any suitable method can be used for curing the epoxy resin composition. One or more of the materials of the curable epoxy resin composition can be dispersed or suspended, as particles.

Epoxy resin compositions described herein can be made from a single component (1K) system, a two-component (2K) system, or other multicomponent system. It is also contemplated that epoxy resin compositions described herein are suitable as a storable component for a 2 K system or other multi-component system.

1K systems include all of the necessary ingredients and polymerization does not occur prior to application of a stimulus, for example, heat. 2K systems and other multicomponent systems include two or more components that are mixed prior to use. In some embodiments, a 2K system or a multicomponent system includes (1) a resin component (which may be a mixture of ingredients) and (2) a curative component (which may be a mixture of ingredients). The resin component and the curative component are each made separately by, for example, those conditions described above. The resin component may include an epoxy resin, a first filler, a second filler, an optional additive, or combinations thereof. The curative component may include a curing agent, a first filler, an optional additive, or combinations thereof. Prior to use, the resin component and the curative component can be mixed at any suitable weight ratio and cured by any suitable curing method. A weight ratio of the curative component to the resin component may be from about 5 parts by weight (pbw) to about 100 pbw of the curative component to 100 pbw of the resin component, such as from about 10 pbw to about 90 pbw of the curative component to 100 pbw of the resin component, such as from about 20 pbw to about 80 pbw of the curative component to 100 pbw of the resin component, such as from about 30 pbw to about 60 pbw of the curative component to 100 pbw of the resin component, such as from about 35 pbw to about 55 pbw of the curative component to 100 pbw of the resin component, such as from about 40 pbw to about 50 pbw of the curative component to 100 pbw of the resin component, or from about 35 pbw to about 40 pbw of the curative component to 100 pbw of the resin component, such as about 38.5 pbw of the curative component to 100 pbw of the resin component, though other amounts are contemplated. Any of the foregoing numbers can be used singly to describe an open-ended range or in combination to describe a close-ended range. Further details are described herein.

As described above, the curable epoxy resin composition can be a 1K system, a 2K system, or other multicomponent system. The curable composition, whether a single component or multicomponent system, can be cured under conditions effective to cure the curable epoxy resin composition. The selected curing conditions can depend on, for example, the temperature at which the curing agent causes reactions to occur that result in coupling, cross-linking, or both, of the epoxy resin among other materials. Such curing conditions can include heating the composition to a temperature that is ambient temperature or higher than ambient temperature, such as from about 30° C. to about 300° C., such as from about 40° C. to about 285° C., such as from about 50° C. to about 275° C., such as from about 75° C. to about 250° C., such as from about 100° C. to about 225° C., such as from about 125° C. to about 200° C., such as from about 150° C. to about 175° C., or from about 30° C. to about 100° C., such as from about 35° C. to about 80° C., such as from about 40° C. to about 70° C., though other temperatures are contemplated. Any of the foregoing numbers can be used singly to describe an open-ended range or in combination to describe a close-ended range.

Curing conditions can include curing for any suitable amount of time, such as from about 1 minute to about 48 hours, such as from about 30 minutes to about 24 hours, such as from about 1 hour to about 20 hours, such as from about 3 hours to about 15 hours, such as from about 5 hours to about 10 hours, though other periods are contemplated. Any of the foregoing numbers can be used singly to describe an open-ended range or in combination to describe a close-ended range. Curing can be performed in stages, such as cure cycles. For example, a cure cycle can include curing the composition at a first temperature at a first time; raising the temperature at a selected heating rate to a second temperature; and curing the composition at the second temperature for a second time. As a non-limiting example, the cure cycle can have the following profile: curing at a temperature of about 25° C. to about 55° C. (such as about 40° C.) for a period of about 10 hours to about 20 hours (such as about 14 hours); raising the temperature to about 50° C. to about 90° C. (such as about 70° C.), at a rate of about 1° C./minute to about 10° C./minute (such as about 5° C./minute); and then curing at about 50° C. to about 90° C. (such as about 70° C.) for a period of about 2 hours to about 6 hours (such as about 4 hours). Other cures or cure cycles are contemplated.

If desired, the curable composition can be introduced to a mold prior to curing. That is, the curable composition can be shaped (for example, molded) into any suitable shape. Depending on the application for which the composition is to be used, corresponding shaping of the mixture that is produced can be carried out. Curing can then take place at a selected temperature or temperature range depending on the temperature at which the curing agent used becomes active. The cured composition may then be positioned on a substrate.

Alternatively, curable epoxy resin compositions can be applied to a substrate (such as a plastic or composite material) and then cured by any suitable methods such as those methods described herein.

Embodiments of the present disclosure also generally relate to uses of epoxy resin compositions described herein such as articles of manufacture. Epoxy resin compositions of the present disclosure can be utilized as an adhesive to, for example, bond, fuse, join, glue, or otherwise adhere components of an article of manufacture to one another. Epoxy resin compositions of the present disclosure can be utilized as a structural adhesive, for example, a low-density adhesive for structural bonding. In some embodiments, epoxy resin compositions are epoxy resin compositions to bond, join, or adhere two components together.

In some embodiments, an article includes a substrate and an epoxy resin composition described herein. The article can be a component of any component that benefits from lightweight properties and good mechanical properties. The article can be a component of a wind turbine blade, a vehicle (including automobiles, watercraft, and aircraft, or other transportation), construction, installation, and sport equipment.

In some embodiments, the epoxy resin composition (whether cured or not) can contact, directly or indirectly, a substrate. The composition can be adhered to, disposed over, encapsulate, or otherwise cover at least a portion of the substrate. The substrate can define one or more components (such as structural components or mechanical components) of an apparatus or component thereof that are exposed to, for example, mechanical stress, thermal stress, or centrifugal forces, among other damaging or degrading forces. The substrate can be any component that benefits from lightweight properties and good mechanical properties. The substrate can be a component, part, piece, or element of a wind turbine blade, a vehicle (including automobiles, watercraft, and aircraft, or other transportation), construction, installation, and sport equipment.

Epoxy resin compositions described herein can be utilized with any suitable substrate such as a composite material. Suitable substrates can include, but are not limited to, a plastic, a glass fiber-reinforced plastic, a carbon-fiber reinforced plastic, a rubber, or combinations thereof.

In at least one embodiment, an article includes a first component comprising a surface, a second component comprising a surface, and an epoxy resin composition disposed between the surfaces of the first and second components. The epoxy resin composition can serve to adhere the first and second components together. The first and second components can be a substrate described herein.

With respect to wind turbine blades, components of wind turbine blades that serve as substrates can include, but are not limited to, a shear web, a shell (for example, a half shell such as an upper shell and a lower shell), a mounting flange, a component thereof, or combinations thereof. These substrates are typically made of composite material. Wind turbine blades typically include a hollow shell made up of two half shells bonded together along leading and trailing edges of the shells. A longitudinally-extending shear web(s) is provided within the internal cavity of the blade. A shear web includes a web panel disposed between upper and lower mounting flanges. The mounting flanges are bonded respectively to oppose inner surfaces of the two half-shells. Adhesives, such as epoxy resin compositions, can be used during assembly of the wind turbine blade to bond, join, or adhere, various components of wind turbine blades to one another. For example, the shear web(s) are bonded to the inner surface of the first half shell. Here, an adhesive can be applied to the inner surface of the first half shell, and the shear webs can then be lifted into the first half shell and positioned with their lower mounting flanges on top of the adhesive. Adhesive may also be applied to the upper mounting flange of the shear web and further adhesive may be applied along leading and trailing edges of the first half shell. The adhesive can then be allowed to cure.

Generally, a wind turbine blade can include a first and second half shell joined together and a shear web bonded between inner surfaces of the respective half shells. Adhesive, such as an epoxy resin composition described herein, can be provided between the shear web and the inner surfaces of the respective half shells. In some embodiments, a method of manufacturing a wind turbine blade includes one or more of the following operations:
(a) providing a first half shell and second half shell of the wind turbine blade;
(b) providing a shear web comprising a web panel disposed between first and second mounting flanges;
(c) disposing an epoxy resin composition described herein between a first mounting flange of the shear web and an inner surface of the first half shell;
(d) disposing an epoxy resin composition described herein between the second mounting flange of the shear web and the inner surface of the second half shell; and
(e) joining the first and second half shells together while bonding the shear web to the first and second half shells.

Any of the above operations can include heating the epoxy resin composition.

In some examples, an epoxy resin composition described herein can be deposited on or coated on a substrate surface by using any suitable technique, such as by dipping, spraying, or immersing, among other techniques. Additionally, or alternatively, the substrate can be placed into a mold and encapsulated with an epoxy resin composition described herein.

An article described herein can be made by any suitable method. In at least one embodiment, a method of forming an article comprises: disposing a curable composition (such as an epoxy resin composition described herein) on a substrate; and heating the substrate and the curable composition to form a cured composition on the substrate.

Additionally, or alternatively, a method of forming an article comprises: disposing a curable composition (such as an epoxy resin composition described herein) on a first substrate; positioning a second substrate on the curable composition; and heating the curable composition to join the first and second substrates. In any suitable method, the heating the curable composition can be performed at any suitable temperature for any suitable duration such as those temperatures and durations described herein, such as from about 30° C. to about 100° C., such as from about 35° C. to about 80° C., such as from about 40° C. to about 70° C., though other temperatures are contemplated. Any of the foregoing numbers can be used singly to describe an open-ended range or in combination to describe a close-ended range.

If desired, compositions described herein can be used for other applications such as for use in the coatings industries. The compositions can be used generally for producing composites, coatings, adhesives, insulation materials, shaped products, binders, paints, sealants, laminates, among other articles and articles of manufacture. The epoxy resin compositions can be used as casting compositions (reaction compositions), molding compositions (reaction resin compositions), as prepregs, among other applications. The epoxy resin compositions can be used in electrical engineering, for example for sheathing electrical and electronic components such as capacitors, collectors, and resistors.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

Examples of compositions described herein and comparative example compositions were made using various materials set out in the Materials and are described further below. Selected properties of the compositions were measured using Test Methods.

### Materials

Non-limiting epoxy resins used for the example and comparative example compositions included Epikote Resin 828 and Epikote Resin 862 commercially available from Westlake Epoxy Inc. Epikote Resin 828 is a difunctional bisphenol-A-diglycidyl-ether epoxy resin. Epikote Resin 862 is a difunctional bisphenol-F-diglycidyl-ether epoxy resin.

Heloxy Modifier HD was used as an example viscosity modifier or reactive diluent and is a diglycidyl ether of 1,6-hexanediol, commercially available from Westlake Epoxy Inc. Paraloid TMS-2670J was utilized as a non-limiting impact modifier for the example and comparative example compositions. Paraloid TMS-2670J is a methyl methacrylate butadiene styrene (MBS) core shell rubber impact modifier and is commercially available from Dow Chemical Company.

Non-limiting fillers used for the example and comparative example compositions included: Cab-o-sil TS-720 (a polydimethylsiloxane pre-treated fumed silica; density of 2.2 g/cm³; and commercially available from Cabot Corporation); HDK N20 (a hydrophilic silane pre-treated fumed silica; density of 2.2 g/cm³; and commercially available from Wacker Chemie AG), FG 400/060 (a filler based on milled E-glass fibers; density of 2.55 g/cm³ to 2.66 g/cm³; an average fiber length of 230 μm; a fiber diameter of 9 μm to 14 μm; and commercially available from Schwarzwälder Textil-Werke Heinrich Kautzmann GmbH); Filtracel EFC 450 (a chemithermomechanical pulp; density of 1.5 g/cm³; and commercially available from J. Rettenmaier & Söhne GmbH+CoKG); and Expancel 920 DE 40 d30 (expanded thermoplastic microspheres; density of 0.03 g/cm³; particle size D (0.5) from 35 μm to 55 μm; and commercially available from Nouryon).

Non-limiting curing agents used for the example and comparative example compositions included Epikure Curing Agent 3140B (EK 3140B, commercially available from Westlake Epoxy Inc.), isophorone diamine (commercially available from Evonik Operations GmbH), Jeffamine D-230 polyetheramine (commercially available from Huntsman Corporation), Jeffamine D-400 polyetheramine (commercially available from Huntsman Corporation) and Jeffamine XTJ 568 (commercially available from Huntsman Corporation). EK 3140B is a multifunctional polyamidoamine, isophorone diamine is 3-(aminomethyl)-3,5,5-trimethylcyclohexan-1-amine, Jeffamine D-230 polyetheramine is a difunctional primary amine with an average molecular weight of about 230 g/mol. Jeffamine D-400 polyetheramine is a difunctional primary amine with an average molecular weight of about 430 g/mol, and Jeffamine XTJ 568 is a reaction mass of 1-[2-(2-aminobutoxy) ethoxy]but-2-ylamine and 1-({[2-(2-aminobutoxy) ethoxy]methyl}propoxy) but-2-ylamine.

Non-limiting additives used for the example and comparative example compositions included Sudan Yellow 146 colorant (commercially available from John Hogg Technical Solutions Ltd.) and Sudan Blue 670 colorant (commercially available from BASF SE).

### Test Methods

Density (at 20° C.) of epoxy resin compositions was determined according to DIN EN ISO 1183-1. This density of the epoxy resin compositions is the density of the cured resin/hardener system and is distinct from the density of the fillers.

Tensile strength and tensile strain at break of epoxy resin compositions were determined according to DIN EN ISO 527-2.

Fracture toughness (G_{IC}, at 23° C.) of epoxy resin compositions was determined according to ISO 13586:2000. The procedure for measuring fracture toughness included measuring using single-edge-notch bending (SENB) geometry, and determining the critical energy release rate (G_{IC}).

Pot life of the epoxy resin compositions was determined by DIN EN 14022-procedure 5: Determination by means of exothermic reaction temperature; with a 100 g system at 30° C. in a water bath. Resin components and curative components were both tempered to 29.5+0.5° C. prior to mixture. Pot life is the period of time in which the epoxy resin composition can be used after mixing.

Glass transition temperature was measured by DIN EN ISO 11357-1 via DSC (differential scanning calorimetry) after fully curing the epoxy resin composition at 180° C. for 3 hours. DSC midpoint (T_{1/2,g}) was measured with a ramping rate of 20° C./min between 25° C. and 150° C.

### Example Compositions

Example compositions and comparative example compositions were prepared using the components shown in Table 1. The amounts shown in Table 1 are in units of weight percent unless indicated otherwise. Selected mechanical properties of the compositions are also shown in Table 1. In Table 1, “Ex.” refers to an example of the present disclosure, and “C.Ex.” refers to a comparative example.

The Example 1 epoxy resin composition includes first fillers as Cab-o-sil TS-720 and HDK N20, and a second filler as Expancel 920 DE 40 d30. Cab-o-sil TS-720 and HDK N20 each have a density greater than 0.2 g/cm³, while Expancel 920 DE 40 d30 has a density of 0.2 g/cm³ or less.

The Comparative Example 1 and Comparative Example 2 compositions, in contrast, do not include second fillers (those fillers having density of 0.2 g/cm³ or less). Comparative Example 1 and Comparative Example 2 compositions include only first fillers which are fillers that have a density of greater than 0.2 g/cm³.

The example and comparative example epoxy resin compositions were made according to the following non-limiting procedure. In separate vessels, the resin components were made into a resin bonding paste and the curative components were made into a curative bonding paste.

Resin bonding paste. A first portion of the Blend of Epikote Resin 828 and Epikote Resin 862 epoxy resin (about 550 kg) was charged into a stainless steel vessel. Subsequently, with the aid of a high shear device, Paraloid TMS-2670J impact modifier (about 43 kg) were drawn in under shear conditions. After completion of the drawing-in, the suction nozzle was closed and the mixture was subsequently additionally sheared. Subsequently, a second portion of the Blend of Epikote Resin 828 and Epikote Resin 862 epoxy resin (about 680 kg) was drawn into the vessel, followed by Sudan Yellow 146 colorant (about 0.05 kg). After that, and with the aid of the suction nozzle of the high shear mixer, the Cab-o-sil TS-720 filler was drawn into the vessel. Expancel 920 DE 40 d30 (about 6 kg) was then drawn into the vessel using the suction nozzle of the high shear mixer. The resulting mixture was slowly stirred for about 10 minutes, and placed under vacuum (about 5,000 Pascals (Pa)) for about 15 minutes to degas the formed resin bonding paste.

Curative bonding paste. In a separate vessel, the EK 3140B curing agent (about 863 kg), isophorone diamine curing agent (about 107 kg), and Jeffamine D-230 curing agent (about 948 kg) were charged into a stainless steel vessel. Subsequently, with the aid of the suction nozzle of the high shear mixer, the HDK N20 filler (about 249 kg) was drawn in under shear conditions. The resulting mixture was slowly stirred for about 2 minutes, and placed under vacuum (about 5,000 Pa) for about 15 minutes to degas the formed curative bonding paste.

The resin bonding paste and the curative bonding paste were then mixed at a ratio of 100 parts by weight of resin bonding paste to 38.5 parts by weight of the curative bonding paste. The resulting mixture was mixed, cured at a temperature of about 40° C. for about 14 hours, and then post-cured for about 4 hours at a temperature of about 70° C.

TABLE 1

| | Ex. 1 | C. Ex. 1 | C. Ex. 2 |
|---|---|---|---|
| Resin components | | | |
| Epikote Resin 828, wt % | 77.958 | 58.269 | 85.000 |
| Epikote Resin 862, wt % | 12.691 | 14.644 | — |
| Heloxy ™ Modifier HD, wt % | — | 6.250 | — |
| Paraloid TMS-2670J, wt % | 3.045 | — | 3.000 |
| Cab-o-sil TS-720, wt % | 5.878 | 6.448 | 7.000 |
| Expancel 920 DE 40 d30, wt % | 0.425 | — | — |
| FG 400/060, wt % | — | 14.384 | — |
| Filtracel EFC 450, wt % | — | — | 5.000 |
| Sudan Yellow 146, wt % | 0.004 | 0.005 | — |
| Total of resin components, wt % | 100.000 | 100.000 | 100.000 |
| Curative components | | | |
| EK 3140B, wt % | 39.823 | 35.198 | 39.823 |
| Isophorone diamine, wt % | 4.938 | 15.649 | 4.938 |
| Jeffamine D-230 polyetheramine, wt % | 43.745 | — | 43.745 |
| Jeffamine D-400 polyetheramine, wt % | — | 15.649 | — |
| Jeffamine XTJ 568, wt % | — | 11.749 | — |
| HDK N20, wt % | 11.490 | 7.25 | 11.490 |
| FG 400/060, wt % | — | 14.499 | — |
| Sudan Blue 670, wt % | 0.004 | 0.004 | 0.004 |
| Total of curative components, wt % | 100.000 | 100.000 | 100.000 |
| Ratio of resin components to curative | 100:38.5 | 100:45 | 100:36.4 |
| components in epoxy resin composition, | | | |
| parts by weight | | | |
| Total of filler components in epoxy resin | 7.745 | 21.117 | 11.864 |
| composition, wt % | | | |
| Properties | | | |
| Density (20° C.), g/cm³ | 1.061 | 1.2800 | 1.190 |
| Tensile strength (23° C.), (MPa) | 47.8 | 70.0 | 63.6 |
| Tensile strain at break (23° C.), % | 6.76 | 2.9 | 3.63 |
| Fracture toughness (23° C.), J/m² | 3,011 | 1,716 | 1,989 |
| Pot life (30° C.), minutes | 180 | 165 | 110 |
| Glass-transition temperature midpoint, ° C. | 90 | 90 | 94 |

With respect to Example 1, the combined formulation that includes both the resin components and the curative components at the ratio of 100:38.5 is as follows: epoxy resin (about 65.5 wt %), curing agent (about 24.6 wt %), impact modifier (about 2.2 wt %), first filler (about 7.4 wt %), second filler (about 0.3 wt %), and an optional additive (about 0.004 wt % of colorant).

Overall, the data for the composition of Example 1 indicates that, even with a total filler load mass of about 7.7 wt % resulting in a density of about 1.061 g/cm³, excellent mechanical properties are unexpectedly achieved. Here, the composition of Example 1 includes expanded thermoplastic microspheres as an example second filler (a filler having a density of less than 0.2 g/cm³) which leads to the significantly lower density and weight relative to the comparative examples.

For example, it was determined that the tensile strain at break of the Example 1 composition (about 6.76%) was significantly higher than that of the Comparative Example 1 composition (2.9%) and the Comparative Example 2 composition (3.63%), representing a significant increase in tensile strain of about 86% and about 133%, respectively. The fracture toughness of the Example 1 composition (about 3,011 J/m2) was significantly higher than that of the Comparative Example 1 composition (1,716 J/m2) and the Comparative Example 2 composition (1,989 J/m2), representing a significant increase in fracture toughness of about 75% and about 51%, respectively.

These mechanical property benefits are observed even with the significantly lower weight and density of the compositions. Here, the density of the Example 1 composition (about 1.061 g/cm³) was significantly lower than that of the Comparative Example 1 composition (1.28 g/cm³) and the Comparative Example 2 composition (1.190 g/cm³), representing a significant decrease in density of about 17% and about 11%, respectively. Overall, the mechanical property data indicates that epoxy resin compositions of the present disclosure are well-suited to a variety of applications including for use in wind turbine blades.

In addition, the pot life of the Example 1 composition (about 180 min) was significantly higher than the comparative compositions—about 10% higher than the Comparative Example 1 composition and about 64% higher than the Comparative Example 2 composition. Relative to conventional compositions, this result indicates that a manufacturer has significantly more time to utilize epoxy resin compositions described herein after mixing together the components of the epoxy resin composition. Further, epoxy resin compositions described herein have a glass transition temperature value (about 90° C.) on par with conventional compositions (90° C. and 94° C.). Overall, the pot life and glass transition temperature indicate that epoxy resin compositions described herein are well suited for various applications, including use in wind turbine blades.

Sagging, a slow flow of the mixed bonding paste on vertical surfaces, was also investigated. The sag resistance (the ability of the epoxy resin composition to resist sagging) was also determined to be high, indicating that the epoxy resin composition resists bending or drooping on inclined or vertical surfaces. It was also determined that the individual components (the resin component mixture and the curative component mixture) do not separate upon storage of up to 24 months. Overall, the data presented indicates that epoxy resin compositions described herein can be used as adhesives. Further, the data presented indicates that epoxy resin compositions described herein have an excellent balance of low density and good mechanical properties, not observed with conventional lightweight adhesives.

Wind turbine blades, vehicles, sport equipment and other articles of manufacture are built from composite materials as lightweight construction. Therefore, such articles benefit from use of low-density materials, including the adhesives utilized to bond various components and parts of the articles. However, conventional low-density adhesives suffer from poor mechanical properties and the inability to resist mechanical loads, rendering such conventional adhesives not useful in applications where structural integrity is important. In contrast, formulated adhesives (epoxy resin compositions) described herein are well-suited for a variety of adhesive/bonding applications, as the epoxy resin compositions of the present disclosure maintain or achieve superior mechanical performance while at the same time having lower density than conventional adhesives.

Embodiments described herein generally relate to epoxy resin compositions and to uses of epoxy resin compositions such as articles of manufacture. Epoxy resin compositions can be utilized for wind turbine blades among other applications. In contrast to conventional compositions that add significant weight to wind turbine blade designs, epoxy resin compositions described herein are lightweight while maintaining excellent mechanical properties. The improved mechanical properties, lower density, and balance thereof, of epoxy resin compositions described herein can help improve construction and design, leading to significant savings.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a filler” includes aspects comprising one, two, or more fillers, unless specified to the contrary or the context clearly indicates only one filler is included.

While the foregoing is directed to aspects of the present disclosure, other and further aspects of the disclosure may be devised without departing from the basic scope thereof, and the scope thereof is determined by the claims that follow.

1. An epoxy resin composition, comprising:
an epoxy resin;
an impact modifier;
a curing agent;
a first filler having a density of greater than 0.2 g/cm³; and
a second filler having a density of 0.2 g/cm³ or less, the second filler comprising a different filler than the first filler, the second filler comprising a thermoplastic.

2. The epoxy resin composition of claim 1, wherein when the epoxy resin composition is cured, the cured epoxy resin composition has:
a fracture toughness (at 23° C.) that is about 1,500 J/m2 or more;
a tensile strain at break (at 23° C.) of about 4% or more;
a density (at 20° C.) that is about 1.10 g/cm³ or less; or
combinations thereof.

3. The epoxy resin composition of claim 1, wherein a weight ratio of the first filler to the second filler is from about 3:1 to about 60:1.

4. The epoxy resin composition of claim 1, wherein the epoxy resin composition comprises:
from about 5 wt % to about 97.45 wt % of the epoxy resin based on a total wt % of the epoxy resin composition;
from about 0.5 wt % to about 20 wt % of the impact modifier based on the total wt % of the epoxy resin composition;
from about 2 wt % to about 40 wt % of the curing agent based on the total wt % of the epoxy resin composition;
from greater than 0 wt % to about 30 wt % of the first filler based on the total wt % of the epoxy resin composition; and
from about 0.05 wt % to about 5 wt % of the second filler based on the total wt % of the epoxy resin composition, wherein the total wt % of the epoxy resin composition is 100 wt %.

5. The epoxy resin composition of claim 1, wherein the epoxy resin composition comprises:
from about 16 wt % to about 93.23 wt % of the epoxy resin based on a total wt % of the epoxy resin composition;
from about 0.7 wt % to about 15 wt % of the impact modifier based on the total wt % of the epoxy resin composition;
from about 3 wt % to about 40 wt % of the curing agent based on the total wt % of the epoxy resin composition;
from about 3 wt % to about 25 wt % of the first filler based on the total wt % of the epoxy resin composition; and
from about 0.07 wt % to about 4 wt % of the second filler based on the total wt % of the epoxy resin composition, wherein the total wt % of the epoxy resin composition is 100 wt %.

6. The epoxy resin composition of claim 1, wherein:
the epoxy resin composition further comprises from about 0.01 wt % to about 10 wt % of one or more additives based on a total wt % of the epoxy resin composition, the total wt % of the epoxy resin composition is 100 wt %; and
the one or more additives comprise a viscosity modifier, a colorant, a wetting and dispersing additive, a surface additive, a rheology additive, a defoamer, an air release additive, an adhesion promoter, a coupling agent, a processing additive, or combinations thereof.

7. The epoxy resin composition of claim 1, wherein a total wt % of the first filler and the second filler is from about 1 wt % to about 40 wt % based on a total wt % of the epoxy resin composition, the total wt % of the epoxy resin composition is 100 wt %.

8. The epoxy resin composition of claim 1, wherein the first filler of the epoxy resin composition comprises quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, basalt, magnesium carbonate, magnesium sulfate, barium sulfate, polydimethylsiloxane pre-treated fumed silica, hydrophilic silane pretreated silica, chemithermomechanical pulp, epoxy-silane pre-treated silica, epoxy-silane pre-treated wollastonite, cotton, or combinations thereof.

9. The epoxy resin composition of claim 1, wherein the density of the second filler is less than about 0.1 g/cm³.

10. The epoxy resin composition of claim 7, wherein:
the thermoplastic comprises polyacrylonitrile, polyurethane, polyamide, polyetherester, polyolefin, polypropylene, polyethylene, polystyrene, polymethacrylate, polymethylmethacrylate, copolymers thereof, or combinations thereof;
the epoxy resin of the epoxy resin composition is derived from a compound comprising bisphenol A, bisphenol F, tetraglycidyl-methylenedianiline, terephthalic acid, phthalic acid, hexahydrophthalic acid, halogenated bisphenol, novolac, ortho-aminophenol, para-aminophenol, flourenone bisphenol, dicyclopentadiene, or combinations thereof; or
combinations thereof.

11. The epoxy resin composition of claim 1, wherein the impact modifier comprises polyvinylchloride, methyl methacrylate butadiene styrene, polybutadiene, butadiene-acrylic copolymer, polybutadiene-polymethacrylate block copolymer, polysiloxane, polybutylacrylate, polymer modifier with a linear structure based on a functionalized silicone, polybutylacrylate, copolymers thereof, or combinations thereof.

12. An article, comprising:
a first component;
a second component; and
an epoxy resin composition disposed between the first and second components, the epoxy resin composition comprising:
an epoxy resin;
an impact modifier;
a curing agent;
a first filler having a density of greater than 0.2 g/cm³; and
a second filler having a density of 0.2 g/cm³ or less, the second filler comprising a different filler than the first filler, the second filler comprising a thermoplastic.

13. The article of claim 12, wherein the first component, second component, or both comprises plastic, glass fiber-reinforced plastic, carbon-fiber reinforced plastic, rubber, or combinations thereof.

14. The article of claim 12, wherein the article comprises a part of a vehicle.

15. The article of claim 12, wherein the article comprises a part of a sport equipment.

16. A wind turbine blade, comprising:
two components of a wind turbine blade; and
an epoxy resin composition disposed between the two components of the wind turbine blade, the epoxy resin composition comprising:
an epoxy resin;
an impact modifier;
a curing agent;
a first filler having a density of greater than 0.2 g/cm³; and
a second filler having a density of 0.2 g/cm³ or less, the second filler comprising a different filler than the first filler, the second filler comprising a thermoplastic.

17. The wind turbine blade of claim 16, wherein the epoxy resin composition comprises:
from about 1 wt % to about 13 wt % of the first filler based on a total wt % of the epoxy resin composition, the total wt % of the epoxy resin composition is 100 wt %; and
from about 0.01 wt % to about 5 wt % of the second filler based on the total wt % of the epoxy resin composition.

18. The wind turbine blade of claim 16, wherein the epoxy resin composition comprises:
from about 45 wt % to about 85 wt % of the epoxy resin based on a total wt % of the epoxy resin composition, the total wt % of the epoxy resin composition is 100 wt %;
from greater than 0 wt % to about 5 wt % of the impact modifier based on the total wt % of the epoxy resin composition; and
from about 12 wt % to about 36 wt % of the curing agent based on the total wt % of the epoxy resin composition.

19. The wind turbine blade of claim 16, wherein:
the first filler comprises quartz, fumed silica, fused silica, crystalline silica, alumina, kaolin, talc, clay, mica, rock wool, wollastonite, glass powder, glass flakes, glass beads, glass fibers, silicon carbide, silicon nitride, aluminum nitride, carbon black, graphite, titanium dioxide, calcium carbonate, calcium sulfate, barium carbonate, basalt, magnesium carbonate, magnesium sulfate, barium sulfate, polydimethylsiloxane pre-treated fumed silica, hydrophilic silane pretreated silica, chemithermomechanical pulp, epoxy-silane pre-treated silica, epoxy-silane pre-treated wollastonite, cotton, or combinations thereof;
the density of the first filler is greater than 0.1 g/cm³;
the second filler comprises an expandable thermoplastic microsphere;
the density of the second filler is 0.1 g/cm³ or less; or
combinations thereof.

20. The wind turbine blade of claim 16, wherein each of the two components of the wind turbine blade, independently, comprises an upper shell, a lower shell, a shear web, a mounting flange, a component thereof, or combinations thereof.
